(19) United States
(12) Patent Application Publication
(10) Pub. No.: US 2022/0020019 A1
(43) Pub. Date: Jan. 20, 2022

(54) Smart Contract-Based Electronic Contract Forensics Method and System

(71) Applicant: Jiangsu Aowei Holdings Co., Ltd., Nanjing (CN)

(72) Inventor: Jie Bai, Nanjing (CN)

(21) Appl. No.: 17/379,242

(22) Filed: Jul. 19, 2021

(30) Foreign Application Priority Data
Jul. 20, 2020 (CN) 202010699847.9
Sep. 9, 2020 (CN) 202010938075.X

(51) Int. Cl. G06Q 20/40; G06Q 20/38; H04L 9/08; H04L 9/32; G06F 16/22

(52) U.S. Cl. CPC G06Q 20/401; G06Q 20/38215; H04L 9/0825; H04L 2209/56; G06F 16/2255; G06Q 2220/00; H04L 2209/38; H04L 9/3213

(57) ABSTRACT

This application provides a smart contract-based electronic contract forensic method: when a user wants to perform forensic on an electronic contract in a blockchain digital deposit platform, initiating, by an existing electronic contract platform, a forensic request for the electronic contract; obtaining, by the blockchain digital deposit platform, the forensic request and querying deposit information; if a deciding result is that deposit information corresponding to the electronic contract is stored in the blockchain digital deposit platform, deciding whether there is a deposit transaction in the blockchain digital deposit platform; after the deposit transaction is queried in the blockchain digital deposit platform, initiating a forensic transaction to the smart contract in the blockchain digital deposit platform; verifying the forensic transaction, and executing the smart contract, to generate a forensic token; generating an execution result based on the forensic token; obtaining a digest of the deposit transaction based on the execution result; decrypting the digest, to obtain a storage index table; downloading transaction data of the deposit transaction according to a data index; decrypting the transaction data; and verifying validity, legitimacy, and integrity of the decrypted transaction data.

This application claims the priority to the Chinese Application No. 202010699847.9, filed with the Chinese Patent Office on Jul. 20, 2020, and entitled “SMART CONTRACT-BASED ELECTRONIC CONTRACT FORENSIC METHOD AND SYSTEM”, and the Chinese Application No. 202010938075.X, filed with the Chinese Patent Office on Sep. 9, 2020, which are incorporated herein by references in their entirety.

### FIELD OF THE INVENTION

The present invention relates to the field of electronic contract forensic technologies, and in particular, to a smart contract-based electronic contract forensic method and system.

### BACKGROUND OF THE INVENTION

With popularization and development of the Internet, electronic information exchange such as e-commerce and e-government, and electronic transactions have gradually penetrated into all levels of the economy and society. Internet applications play an important role in advancing informationization of the national economy and the society. In economic and social activities, two or more parties are increasingly choosing to reach agreements in an electronic form through electronic information networks, and conclude electronic contracts on the Internet.

The electronic contracts are protected by law, and therefore also have legal effects. The electronic contracts have been widely used due to characteristics such as being easy for storage and being convenient for use. Referring to FIG. 1, FIG. 1 is a schematic scenario diagram of centralized storage of an existing electronic contract platform. Each enterprise has an own electronic contract platform, to store internal electronic contracts of the enterprise and related data. For example, in FIG. 1, enterprise A corresponds to an electronic contract platform A, enterprise N corresponds to an electronic contract platform N, and a plurality of enterprises correspond to a plurality of electronic contract platforms. In an existing electronic contract management platform, electronic contracts and related data of a plurality of electronic contract platforms are stored in a same centralized system. For example, the most common storage mode is storing in a database. Referring to the database storage table shown in FIG. 1, data about all the electronic contract platform of all enterprises may be centrally stored, that is, stored in a centralized way, in the table.

However, because there is only one centralized database, there are risks of data loss, being tampered with, and forged. Information security of electronic contract data retained on the Internet is greatly tested, and credibility in deposit and forensic of the electronic contract is also questioned.

### SUMMARY OF THE INVENTION

This application provides a smart contract-based electronic contract forensic method and system, to resolve a problem that credibility of electronic contract forensic cannot be ensured.

According to a first aspect, there is provided a smart contract-based electronic contract forensic method in this application, including:

initiating a forensic transaction to a blockchain digital deposit platform based on a forensic request for an electronic contract;

verifying the forensic transaction, and executing a smart contract, to generate a forensic token;

generating an execution result based on the forensic token;

obtaining a digest of a deposit transaction based on the execution result;

decrypting the digest, to generate a storage index table;

downloading corresponding pieces of distributed stored data according to the storage index table, and splicing the pieces of data to obtain transaction data; decrypting the transaction data; and

verifying validity, legitimacy, and integrity of the decrypted transaction data, to generate a forensic report.

According to a second aspect, there is provided a smart contract-based electronic contract forensic system in this application, including an electronic contract platform configured to initiate a forensic request, and a blockchain digital deposit platform that receives the forensic request, and accesses an electronic contract based on a smart contract, where

the electronic contract platform is configured to perform:

a request initiating step: initiating a forensic transaction to a blockchain digital deposit platform based on the forensic request for the electronic contract;

the blockchain digital deposit platform is configured to perform:

a forensic token generating step: verifying the forensic transaction, and executing the smart contract, to generate a forensic token;

an execution result generating step: generating an execution result based on the forensic token;

a digest obtaining step: obtaining a digest of a deposit transaction based on the execution result;

a storage index table generating step: decrypting the digest, to generate a storage index table;

a transaction data generating step: downloading corresponding pieces of distributed stored data according to the storage index table, and splicing the pieces of data to obtain transaction data;

a transaction data decrypting step: decrypting the transaction data; and

a verifying step: verifying validity, legitimacy, and integrity of the decrypted transaction data, and after the verification is completed, sending a verification result to the electronic contract platform; and

the electronic contract platform is further configured to perform:

a forensic report generating step: generating a forensic report after the verification result sent by the blockchain digital deposit platform is received.

According to a third aspect, there is provided a smart contract-based electronic contract forensic system in this application, including an electronic contract platform configured to initiate a forensic request, and a blockchain digital deposit platform that receives the forensic request, and accesses an electronic contract based on a smart contract, where

the electronic contract platform is configured to perform:

a request initiating step: initiating a forensic transaction to a blockchain digital deposit platform based on the forensic request for the electronic contract;

the blockchain digital deposit platform is configured to perform:

a forensic token generating step: verifying the forensic transaction, and executing the smart contract, to generate a forensic token;

an execution result generating step: generating an execution result based on the forensic token;

a digest obtaining step: obtaining a digest of a deposit transaction based on the execution result;

a storage index table generating step: decrypting the digest, to generate a storage index table;

a transaction data generating step: downloading corresponding pieces of distributed stored data according to the storage index table, and splicing the pieces of data to obtain transaction data;

a transaction data decrypting step: decrypting the transaction data; and

the electronic contract platform is further configured to perform:

a verifying step: verifying validity, legitimacy, and integrity of the decrypted transaction data, and transmitting a verification result to the blockchain digital deposit platform; and

the blockchain digital deposit platform is further configured to perform:

a forensic report generating step: generating a forensic report after the verification result of the decrypted transaction data which is transmitted by the electronic contract platform is received.

It may be learned from the foregoing technical solutions that there is provided a smart contract-based electronic contract forensic method in this application. When a user wants to perform forensic on an electronic contract in the blockchain digital deposit platform, the existing electronic contract platform initiates the forensic request for the electronic contract. The blockchain digital deposit platform obtains the forensic request and queries the deposit information. If a deciding result is that the deposit information corresponding to the electronic contract is stored in the blockchain digital deposit platform, it is decided whether the deposit transaction exists in the blockchain digital deposit platform. After the deposit transaction is queried in the blockchain digital deposit platform, the forensic transaction is initiated to the smart contract in the blockchain digital deposit platform. The forensic transaction is verified and the smart contract is executed, to generate the forensic token. The execution result is generated based on the forensic token. The digest of the deposit transaction is obtained based on the execution result. The digest is decrypted to obtain the storage index table. The transaction data of the deposit transaction is downloaded according to a data index. The transaction data is decrypted, and the validity, the legitimacy, and the integrity of the decrypted transaction data are verified. In this way, credibility of smart contract-based electronic contract forensic is ensured.

### BRIEF DESCRIPTION OF THE DRAWINGS

To more clearly describe the technical solutions of this application, the accompanying drawings to be used in the embodiments are briefly illustrated below. Obviously, persons of ordinary skills in the art can also derive other accompanying drawings according to these accompanying drawings without creative efforts.

FIG. 1 is a schematic scenario diagram of centralized storage of an existing electronic contract platform;

FIG. 2 is a schematic topology diagram of depositing an electronic contract in a blockchain digital deposit platform;

FIG. 3 is a flowchart of a smart contract-based electronic contract forensic method according to this application;

FIG. 4 is a schematic scenario diagram of a deposit transaction of an electronic contract;

FIG. 5 is a schematic diagram of hierarchically storing transaction data;

FIG. 6 is a schematic diagram of downloading transaction data by using a storage index table;

FIG. 7 is a schematic diagram of a smart contract-based electronic contract forensic system according to an embodiment of this application; and

FIG. 8 is a schematic diagram of a smart contract-based electronic contract forensic system according to another embodiment of this application.

### DETAILED DESCRIPTION OF THE EMBODIMENTS

To make objectives, technical solutions, and advantages of this application more clear, the technical solutions of this application are clearly and completely described below with reference to specific embodiments and corresponding accompanying drawings in this application. Obviously, the described embodiments are merely some embodiments of this application and are not all embodiments. According to the embodiments in this application, all other embodiments derived by persons of ordinary skills in the art without creative efforts fall within the protection scope of this application. The technical solutions provided in the embodiments of this application are described in detail below with reference to the accompanying drawings.

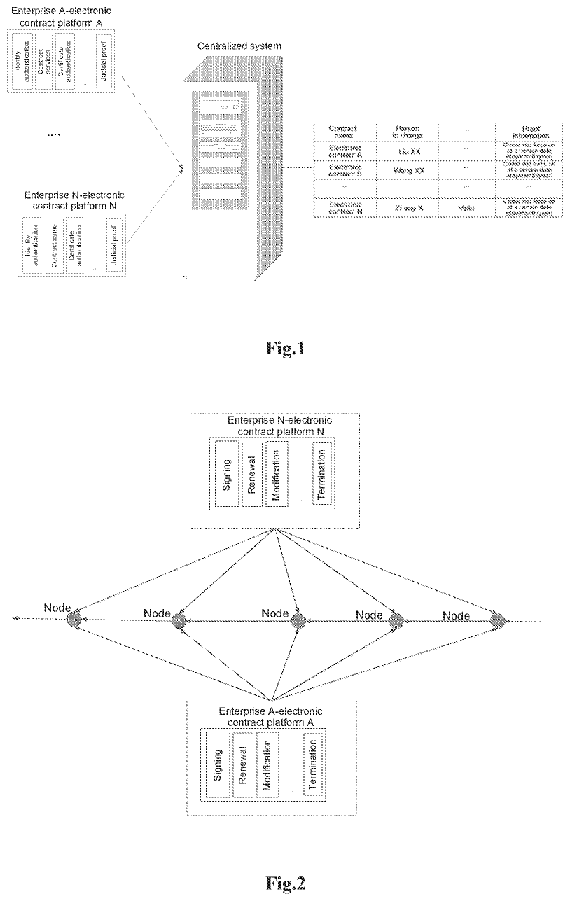

To improve credibility of electronic contract deposit, usually transaction operations, such as signing, renewal, modification, and termination, of the electronic contract have been deposited in a blockchain digital deposit platform. Referring to FIG. 2, FIG. 2 is a schematic topology diagram of depositing an electronic contract in a blockchain digital deposit platform. An electronic contract platform is combined with the blockchain technology to deposit the electronic contract. The credibility of the electronic contract deposit is ensured by using features of a blockchain, such as decentralization, cannot be tampered with, leaving tracks throughout the process, being traceable, being collectively maintained, and being open and transparent. Different from an existing centralized storage method for an electronic contract, in the blockchain digital deposit platform, the electronic contract and related data are stored in various nodes in the blockchain. Therefore, even though data in one or more nodes is damaged, there still are a lot of nodes to store the data. In this way, security of the electronic contract and the related data is ensured. In other words, the electronic contract deposit is credible. To ensure credibility of electronic contract forensic, according to this application, there is provided a smart contract-based electronic contract forensic method and system. A smart contract is a computer protocol aimed at spreading, verifying, or executing a contract by means of information. The smart contract enables trusted transactions without a third party. These transactions are traceable and irreversible, thus ensuring the credibility of electronic contract forensic.

Prior to describing the specific embodiments, to clearly describe and facilitate further understanding of this solution, real scenarios of a deposit transaction and a forensic transaction are introduced below. There are substantially two cases.

Case I: It is known that in which blockchain digital deposit platform is a deposit transaction to be performed with forensic stored. Regarding this case, after a forensic transaction is initiated to the blockchain digital deposit platform based on a forensic request for an electronic contract, forensic may be performed directly.

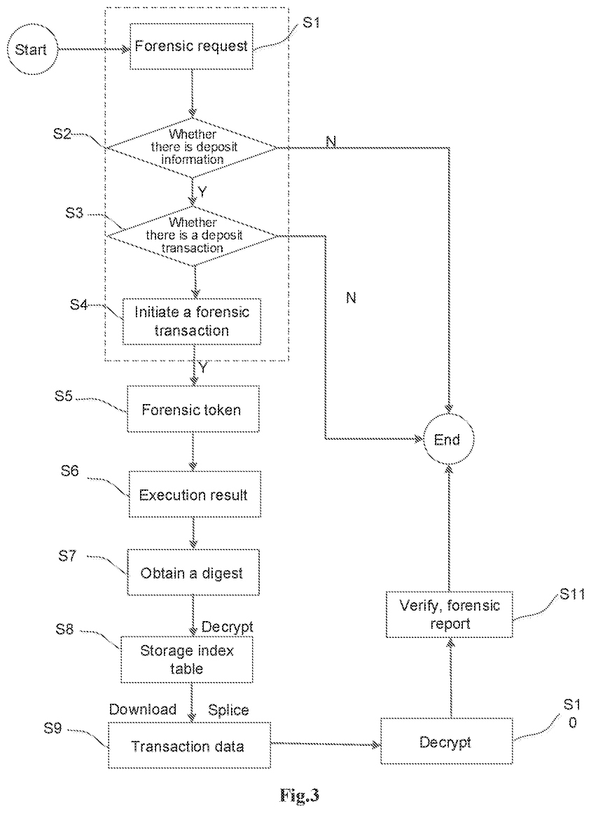

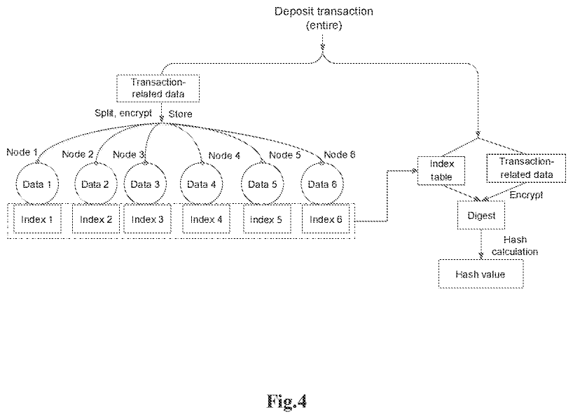

Case II: It is unknown that in which blockchain digital deposit platform is a deposit transaction to be performed with forensic stored. There are a significant number of blockchain digital deposit platforms, or a forensic request may include unqualified information and the like. Regarding this case, after a forensic transaction is initiated to the blockchain digital deposit platform based on a forensic request for an electronic contract, necessary decisions are needed to be performed. Referring to FIG. 3, FIG. 3 is a flowchart of a smart contract-based electronic contract forensic method according to this application. When a user needs to query and retrieve an electronic contract in the blockchain digital deposit platform, a specific implementation process is described with reference to case II, where the following steps are included (correspondingly, if it belongs to case I, steps S1 to S4 in the dashed box may be skipped. In other words, the deposit transaction is in a certain blockchain digital deposit platform by default, the forensic transaction may be directly initiated to the smart contract in the blockchain digital deposit platform).

S1: A forensic request for an electronic contract is obtained.

When a user wants to query and retrieve an electronic contract in the blockchain digital deposit platform, first, a forensic request is initiated by using an existing electronic contract platform. For example, there may be a forensic request button provided on the existing electronic contract platform, and when the button is pressed, the existing electronic contract platform may trigger a forensic request to the blockchain digital deposit platform, that is, a request for querying and retrieving the electronic contract. The blockchain digital deposit platform obtains the forensic request. In this application, when querying and retrieving an electronic contract in the blockchain digital deposit platform, a specific operation method may be carried in the blockchain digital deposit platform, or may be carried on a node that provides proof services. For example, a service node is responsible for maintaining a table, where the table shows which electronic contract is deposited and in which blockchain digital deposit platform is the electronic contract stored. A deposit transaction may have a corresponding serial number. When querying, whether a transaction of the electronic contract has been deposited by a blockchain digital deposit platform may be decided by entering the serial number.

S2: Based on the forensic request, it is decided whether deposit information corresponding to the electronic contract is stored in a blockchain digital deposit platform.

To perform forensic on an electronic contract in the blockchain digital deposit platform, it is required to confirm whether the electronic contract has been deposited in the blockchain digital deposit platform, that is, to query whether deposit information of the electronic contract exists in the blockchain digital deposit platform. It is decided whether the deposit information corresponding to the electronic contract is stored in the blockchain digital deposit platform. If the deposit information exists, it is indicated that the electronic contract has been stored in the blockchain digital deposit platform in advance; and after the deposit information of the electronic contract is queried, a next step may be performed. If the deposit information does not exist, it is indicated that the electronic contract has not been stored in the blockchain digital deposit platform in advance, and the deposit information cannot be queried, the query is ended immediately.

For ease of understanding, a specific use scenario of the deposit transaction of the electronic contract is further introduced herein. Referring to FIG. 4, FIG. 4 is a schematic scenario diagram of a deposit transaction of an electronic contract. Deposit is to save data of a transaction and specific content thereof to the blockchain digital deposit platform. The transaction herein is a series of operations on the blockchain. The deposit transaction is to save data of specific content corresponding to the deposit transaction to the blockchain digital deposit platform, and forensic is to retrieve data related to the deposit transaction.

During an actual operation, a deposit transaction necessarily has an operation instruction and specific data content, and a transaction result is formed after a specific transaction. However, during the transaction, the amount of the data of specific data content may be very large. For example, using electronic contract deposit as an example, the specific data content may include specific contract terms, information about contracting parties, a contract transaction quantity, and the like. If contents such as audios and videos are involved, the amount of data to be stored may be larger. On this basis, to facilitate storage and security of data, usually the entire data of a transaction may be divided into two parts. By using a deposit transaction as an example, referring to FIG. 4, a deposit transaction is taken as a whole, for example, the deposit transaction may be a data packet or a data collection. To facilitate storage and ensure data security, the entire data is divided into two parts, and details are as follows.

The first part of the data is specific transaction-related data stored in the node and a storage relationship index table. In this application, the deposit transaction is stored as a whole, and may be stored in a node in the blockchain digital deposit platform. The node herein may be a dedicated data storage center. In other words, the node serves as a data center. To be specific, where the data is stored is described. A processing process is encrypting a whole deposit transaction, that is, all specific data of the transaction, and splitting the data into a plurality of blocks, or first splitting the data into a plurality of blocks and then performing the encrypting. For example, overall deposit transaction-related data is split into six pieces, where the transaction-related data herein is specific transaction data during the deposit transaction, and are respectively stored in six nodes. At this time, each node stores a piece of data correspondingly. Accordingly, an index is generated for each piece of data stored in the node, and the index is a description of storage location of each piece of data. For example, index 1 is generated for data 1 stored in node 1, and index 2 is generated for data 2 stored in node 2. All indexes constitute a storage relationship index table about all specific transaction data. In FIG. 4, indexes 1 to 6 constitute a storage index table about the integral transaction data.

The second part of the data is the data about the digest, including the storage relationship index table and the transaction-related data in the first part of the data. The transaction-related data herein may refer to, for example, information about both parties of the transaction, a transaction form, and transaction duration. Because an overall data amount of a deposit transaction is very large, it is impractical to store all real data in the blockchain digital deposit platform. If the deposit transaction is entirely packed by using a key, that is, the deposit transaction is encrypted by using the key to have bytes of a fixed-length. For example, a digest is formed after a hash operation is performed on the entire transaction-related data, that is, the specific transaction data of the deposit transaction. Representation of the digest may be a string of hash values, which may become, for example, 256 or 512 bytes after being encrypted, and then the digest is stored in the blockchain digital deposit platform. Because the digest is a package for the entire deposit transaction, the digest also includes the storage relationship index table in the first part of the data. To know which part of data is stored in which node, it is merely required to find out a block where the digest is located, and decrypt the digest to find the index table.

In view of the above, the digest is formed through the following process. The transaction data of the whole deposit transaction (that is, the transaction-related data) is encrypted, and then a hash operation is performed on the encrypted transaction data together with a storage index table generated after distributed storage, to form a digest. In view of the above, the digest is also encrypted.

S3: If the deposit information is stored in the blockchain digital deposit platform, it is decided whether there is a deposit transaction in the blockchain digital deposit platform.

If deposit information corresponding to the electronic contract to be queried is stored in the blockchain digital deposit platform, further it is decided whether there is a deposit transaction corresponding to the deposit information in the blockchain digital deposit platform. If the deposit transaction exists, subsequent steps are performed; and if the deposit transaction does not exist, query is ended.

S4: If the deposit transaction is stored in the blockchain digital deposit platform, a forensic transaction is initiated to a smart contract in the blockchain digital deposit platform.

After the deposit transaction is queried in the blockchain digital deposit platform, a corresponding forensic transaction is constructed in the blockchain digital deposit platform, and the forensic transaction is initiated to the smart contract in the blockchain digital deposit platform. The smart contract may be understood as a program. In this application, smart contract-based electronic contract forensic is to replace forensic with a program by defining certain rules.

S5: The forensic transaction is verified, and the smart contract is executed, to generate a forensic token.

The forensic transaction is verified. Content for verifying is, for example, deciding whether the current forensic transaction is a standard and qualified forensic operation, and whether prohibited or unqualified information is contained. A specific verification scheme is not specifically limited in this application. If the forensic transaction passes the verification, the smart contract is executed at a next step, to generate a forensic token. The forensic token is equivalent to authentication of a qualification for the forensic transaction. Not everyone can arbitrarily perform forensic on the deposit transaction, but only those who meet a predetermined condition and are qualified can perform forensic.

S6: An execution result is generated based on the forensic token.

The forensic token represents a forensic qualification. For example, content of the forensic token may include: being qualified for forensic and unqualified for forensic. A corresponding execution result is generated based on specific content in the forensic token. For example, the execution result may be legal or illegal. Specifically, when the content in the forensic token is being qualified for forensic, the corresponding execution result is legal. Similarly, when the content in the forensic token is unqualified for forensic, the corresponding execution result is illegal.

In combination with S5 and S6, if the forensic transaction does not pass the verification, at this time, the forensic transaction may contain prohibited information or does not conform to a certain predetermined procedure, and thus the smart contract cannot be executed in the next step. A subsequent step may be performed only when the forensic transaction passes the verification. In other words, the smart contract can be executed only when the forensic transaction passes the verification. To ensure implementation of the forensic operation, a forensic transaction needs to be reconstructed at this time. After the reconstruction, the reconstructed forensic transaction is re-initiated to the smart contract in the blockchain digital deposit platform and is verified, until the forensic transaction passes the verification.

S7: A digest of the deposit transaction is obtained based on the execution result.

The digest of the deposit transaction is obtained based on the execution result. Because the electronic contract is deposited in the blockchain digital deposit platform in an encrypted form, the digest obtained at this time is also encrypted.

S8: The digest is decrypted, to generate a storage index table.

During a process of decrypting the digest, a specific encryption and decryption method may be set in advance; this is not specifically limited in this application. A storage index table is generated after the digest is decrypted. It should be noted that before this step, validity of a private-key signature of the deposit transaction may be verified. A specific verification scheme is not specifically limited in this application. If the private-key signature of the deposit transaction is valid, a next step may be performed. If the private-key signature of the deposit transaction is invalid, query is ended.

The private-key signature of the deposit transaction may include a digital signature. A validity verification method of the digital signature is taken as an example. For example, if a sender sends a digitally signed file to the other party, a specific verification process may be that: a digest is generated for a file to be sent by the sender by using a cryptographic hash function (such as MD5, SHA, or SM3); and the sender re-encrypts the digest by using a private key thereof, and after a digital signature is formed, sends original text and the encrypted digest to the other party at the same time. The other party verifies the digest by using a public key of the sender, obtains the digest generated by the sender, and encrypts the received file with SHA encoding to generate another digest. The decrypted digest is compared with the digest that is generated by re-encrypting the received file by the receiver. If the two are consistent, it is indicated that information is not destroyed or tampered with during a transmission process, and the data is integral. In this case, it is verified that the digital signature is valid.

The storage index table records a specific storage location of the transaction data. When the index table is obtained, it is equivalent to that a specific location of the data is learned. By obtaining a data index, data querying efficiency may be accelerated, and particular information in a database table may be quickly accessed.

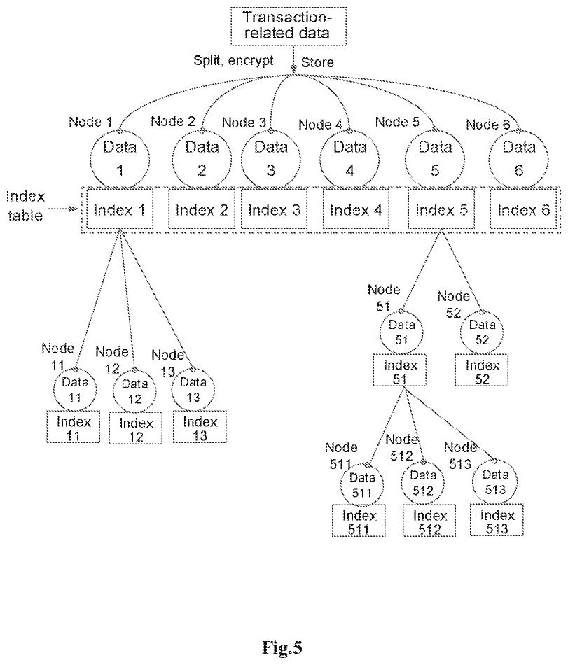

Usually, to further ensure data security, the data is stored in a distributed manner. However, there is also a case in which the data is stored as a whole. To be specific, the specific transaction data of the whole deposit transaction is not split, and is directly stored in a node or data center, and then an index is generated. It is equivalent to that one-level storage corresponds to one index. However, in most cases, a distributed manner is still selected for storing data, that is, the data is split into a plurality of pieces and the plurality of pieces of data are stored at different locations. Referring to FIG. 5, FIG. 5 is a schematic diagram of hierarchically storing transaction data. With reference to specific examples, hierarchical storage in distributed storage is introduced in detail.

Regarding one-level storage, the data is merely split into a plurality of pieces and the plurality of pieces are stored in different nodes or data centers in a distributed manner, including the case of directly storing the entire transaction data as described above. If the entire data is stored in a node A, a corresponding index is A, and there is a sub-index A1 under the index A. If A1 is empty, it is indicated that the data is not stored at a next level, which means that the data is stored at only one level.

Regarding hierarchical storage (storage at two or more levels), with reference to FIG. 5, transaction-related data is stored in a node 1, where an index 1 is correspondingly generated, and the node 1 includes several subnodes. The data is further stored in next-level nodes, where the data is divided into three pieces to be stored in next-level nodes 11, 12, and 13. Sub-indexes which are respectively index 11, index 12, and index 13 are generated at the same time. It may be learned from FIG. 5 that the three sub-indexes together constitute the index 1, and the storage at this time is two-level storage. Similarly, with reference to node 5, the node 5 stores the data to next-level subnodes 51 and 52 in a distributed manner. The subnode 51 further stores the data to its own next-level subnodes 511, 512, and 513 in a distributed manner. Corresponding storage at this time is three-level storage. The other may be obtained by analogy. Hierarchical storage may be performed according to actual requirements.

S9: Corresponding pieces of distributed stored data are downloaded according to the storage index table, and are spliced to obtain transaction data.

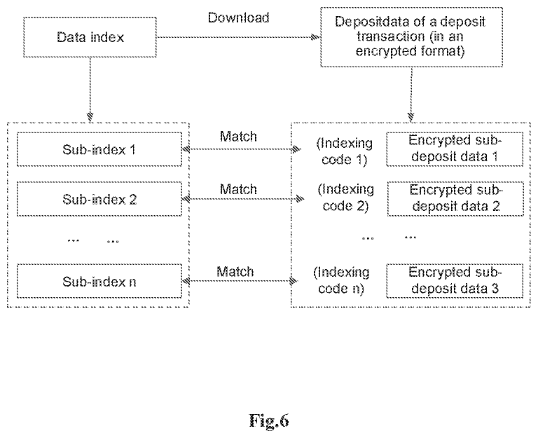

For a specific process of downloading corresponding pieces of distributed stored data according to the storage index table, reference is made to FIG. 6. FIG. 6 is a schematic diagram of downloading transaction data by using a storage index table. It may be learned from FIG. 6 that the storage index table may be split into a plurality of sub-indexes, that is, the storage index table may include a plurality of sub-indexes, such as sub-index 1, sub-index 2, . . . , and sub-index n. The transaction data may include a plurality of pieces of discretized encrypted sub-deposit data, and each piece of the encrypted sub-deposit data contains one indexing code. For example, the indexing code of encrypted sub-deposit data 1 is indexing code 1, and the indexing code of encrypted sub-deposit data n is indexing code n, where the indexing code is unique. In other words, there is no duplication in the plurality of indexing codes. In a process of downloading deposit data by using the storage index table, the plurality of sub-indexes of the storage index table are respectively matched with the plurality of indexing codes of the deposit data. If the sub-index and the indexing code are successfully matched, it is indicated that there may be encrypted sub-deposit data that matches with the sub-index. For example, upon comparison, if it is found that the sub-index 1 matches with the indexing code 1, it is indicated that the encrypted sub-deposit data 1 may be downloaded by using the sub-index 1. In other words, after the successful matching, the encrypted sub-deposit data corresponding to the indexing code that matches with the sub-index is downloaded. After all indexing codes matching with the sub-indexes are found, all pieces of successfully matched encrypted sub-deposit data are downloaded. These pieces of encrypted sub-deposit data form the transaction data after being correctly spliced.

S10: The transaction data is decrypted.

Before step S8, validity of private key information of the user or the electronic contract platform may be verified. If the private-key signature is verified to be valid, in this step, the encrypted transaction data is decrypted by using a valid private key, to generate corresponding decrypted transaction data.

S11: Validity, legitimacy, and integrity of the decrypted transaction data are verified, to generate a forensic report.

To ensure credibility of the decrypted transaction data, the validity, the legitimacy, and the integrity of the decrypted transaction data need to be verified. For example, the integrity of the transaction data may be verified by using a digital signature. A method for verifying the validity, the legitimacy, and the integrity is not specifically limited in this application. A corresponding forensic report may be generated based on a verification result. For example, after the validity, the legitimacy, and the integrity of the transaction data pass the verification, it is indicated that the electronic contract obtained through forensic does come from the blockchain digital deposit platform, and is not damaged in deposit and forensic processes with integral and valid data, thereby ensuring forensic credibility. For a case in which the verification is passed, the forensic report may contain relevant statements about that the verification is passed. If the verification is not passed, there may be descriptions about that the verification is not passed in the forensic report. A forensic report is generated after the validity, the legitimacy, and the integrity of the transaction data are verified, and forensic is ended. Till this time, forensic of the electronic contract is completed.

It may be learned from the foregoing technical solutions that there is provided a smart contract-based electronic contract forensic method in this application. When a user wants to perform forensic on an electronic contract in the blockchain digital deposit platform, the existing electronic contract platform initiates the forensic request for the electronic contract. The blockchain digital deposit platform obtains the forensic request and queries the deposit information. If a deciding result is that the deposit information corresponding to the electronic contract is stored in the blockchain digital deposit platform, it is decided whether the deposit transaction exists in the blockchain digital deposit platform. After the deposit transaction is queried in the blockchain digital deposit platform, the forensic transaction is initiated to the smart contract in the blockchain digital deposit platform. The forensic transaction is verified and the smart contract is executed, to generate the forensic token. The execution result is generated based on the forensic token. The digest of the deposit transaction is obtained based on the execution result. The digest is decrypted to obtain the storage index table. The transaction data of the deposit transaction is downloaded based on a data index. The transaction data is decrypted, and the validity, the legitimacy, and the integrity of the decrypted transaction data are verified. In this way, credibility of smart contract-based electronic contract forensic is ensured.

According to this application, there is provided a smart contract-based electronic contract forensic system, including an electronic contract platform configured to initiate a forensic request, and a blockchain digital deposit platform that receives the forensic request, and accesses an electronic contract based on a smart contract.

### Embodiment 1

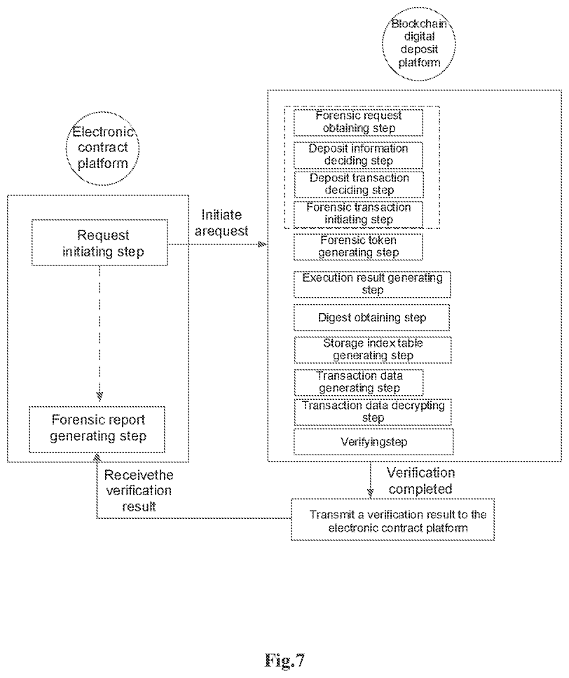

Referring to FIG. 7, FIG. 7 is a schematic diagram of a smart contract-based electronic contract forensic system according to an embodiment of this application. The parts in the dashed box in FIG. 7 are optional processes, which represent decisions on some conditions before forensic is actually performed. To be specific, in case I, these processes do not exist; and in case II, these processes exist. A smart contract-based electronic contract forensic system is provided, including an electronic contract platform configured to initiate a forensic request, and a blockchain digital deposit platform that receives the forensic request, and accesses an electronic contract based on a smart contract. The electronic contract platform is configured to perform:

a request initiating step: initiating a forensic transaction to a blockchain digital deposit platform based on the forensic request for the electronic contract.

The blockchain digital deposit platform is configured to perform:

a forensic token generating step: verifying the forensic transaction, and executing the smart contract, to generate a forensic token;

an execution result generating step: generating an execution result based on the forensic token;

a digest obtaining step: obtaining a digest of a deposit transaction based on the execution result;

a storage index table generating step: decrypting the digest, to generate a storage index table;

a transaction data generating step: downloading corresponding pieces of distributed stored data according to the storage index table, and splicing the pieces of data to obtain transaction data;

a transaction data decrypting step: decrypting the transaction data; and

a verifying step: verifying validity, legitimacy, and integrity of the decrypted transaction data, and after the verification is completed, sending a verification result to the electronic contract platform.

The electronic contract platform is further configured to perform:

a forensic report generating step: generating a forensic report after the verification result sent by the blockchain digital deposit platform is received.

Further, the initiating a forensic transaction to a blockchain digital deposit platform based on the forensic request for the electronic contract is performed according to the following steps:

a forensic request obtaining step: obtaining the forensic request for the electronic contract;

a deposit information deciding step: deciding, based on the forensic request, whether deposit information corresponding to the electronic contract is stored in the blockchain digital deposit platform;

a deposit transaction deciding step: if the deposit information is stored in the blockchain digital deposit platform, deciding whether the deposit transaction exists in the blockchain digital deposit platform; and

a forensic transaction initiating step: if the deposit transaction is stored in the blockchain digital deposit platform, initiating the forensic transaction to the smart contract in the blockchain digital deposit platform.

Further, the blockchain digital deposit platform is further configured to perform a step of verifying validity of a private key, to verify validity of a private-key signature of the deposit transaction. If the private-key signature is valid, the digest is decrypted to generate the storage index table.

Further, the blockchain digital deposit platform is further configured to perform a forensic transaction reconstructing step. If the forensic transaction does not pass the verification, the forensic transaction is re-initiated to the smart contract in the blockchain digital deposit platform; the forensic transaction is re-verified, until the forensic transaction passes the verification.

Further, the transaction data includes several pieces of discretized encrypted sub-deposit data, each piece of the encrypted sub-deposit data contains one indexing code, and the indexing code is unique.

Further, the downloading corresponding pieces of distributed stored data according to the storage index table, and splicing the pieces of data to obtain transaction data includes the following steps:

splitting the storage index table into several sub-indexes;

respectively matching the plurality of sub-indexes with the plurality of indexing codes, and if a sub-index is successfully matched with an indexing code, downloading the encrypted sub-deposit data corresponding to the indexing code; and

splicing the plurality of pieces of encrypted sub-deposit data to form the transaction data.

### Embodiment 2

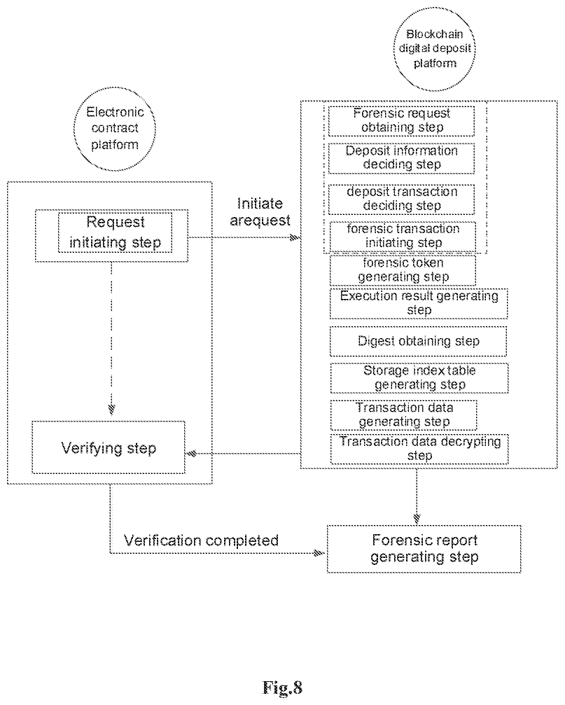

Referring to FIG. 8, FIG. 8 is a schematic diagram of a smart contract-based electronic contract forensic system according to another embodiment of this application. The parts in the dashed box in FIG. 8 are optional processes, which represent decisions on some conditions before forensic is actually performed. To be specific, in case I, these processes do not exist; and in case II, these processes exist. A smart contract-based electronic contract forensic system is provided, including an electronic contract platform configured to initiate a forensic request, and a blockchain digital deposit platform that receives the forensic request, and accesses an electronic contract based on a smart contract.

The electronic contract platform is configured to perform:

a request initiating step: initiating a forensic transaction to a blockchain digital deposit platform based on the forensic request for the electronic contract.

the blockchain digital deposit platform is configured to perform:

a forensic token generating step: verifying the forensic transaction, and executing the smart contract, to generate a forensic token;

an execution result generating step: generating an execution result based on the forensic token;

a digest obtaining step: obtaining a digest of a deposit transaction based on the execution result;

a storage index table generating step: decrypting the digest, to generate a storage index table;

a transaction data generating step: downloading corresponding pieces of distributed stored data according to the storage index table, and splicing the pieces of data to obtain transaction data;

a transaction data decrypting step: decrypting the transaction data.

The electronic contract platform is further configured to perform:

a verifying step: verifying validity, legitimacy, and integrity of the decrypted transaction data, and transmitting a verification result to the blockchain digital deposit platform.

The blockchain digital deposit platform is further configured to perform:

a forensic report generating step: generating a forensic report after the verification result of the decrypted transaction data which is transmitted by the electronic contract platform is received.

Further, the initiating a forensic transaction to a blockchain digital deposit platform based on the forensic request for the electronic contract is performed according to the following steps:

a forensic request obtaining step: obtaining the forensic request for the electronic contract;

a deposit information deciding step: deciding, based on the forensic request, whether deposit information corresponding to the electronic contract is stored in the blockchain digital deposit platform;

a deposit transaction deciding step: if the deposit information is stored in the blockchain digital deposit platform, deciding whether the deposit transaction exists in the blockchain digital deposit platform; and

a forensic transaction initiating step: if the deposit transaction is stored in the blockchain digital deposit platform, initiating the forensic transaction to the smart contract in the blockchain digital deposit platform.

Further, the blockchain digital deposit platform is further configured to perform a step of verifying validity of a private key, to verify validity of a private-key signature of the deposit transaction. If the private-key signature is valid, the digest is decrypted to generate the storage index table.

Further, the blockchain digital deposit platform is further configured to perform a forensic transaction reconstructing step. If the forensic transaction does not pass the verification, the forensic transaction is re-initiated to the smart contract in the blockchain digital deposit platform, to re-verify the forensic transaction, until the forensic transaction passes the verification.

Further, the transaction data includes several pieces of discretized encrypted sub-deposit data, each piece of the encrypted sub-deposit data contains one indexing code, and the indexing code is unique.

Further, the downloading corresponding pieces of distributed stored data according to the storage index table, and splicing the pieces of data to obtain transaction data includes the following steps:

splitting the storage index table into several sub-indexes;

respectively matching the sub-indexes with the plurality of indexing codes, and if a sub-index is successfully matched with the indexing code, downloading the encrypted sub-deposit data corresponding to the indexing code; and

splicing the plurality of pieces of encrypted sub-deposit data to form the transaction data.

The difference between Embodiment 2 and Embodiment 1 is that in embodiment 1, the validity, the legitimacy, and the integrity of the decrypted transaction data are verified by the blockchain digital deposit platform; if the validity, the legitimacy, and the integrity of the decrypted transaction data pass the verification, the blockchain digital deposit platform sends a verification result to the electronic contract platform, that is, the blockchain digital deposit platform performs a forensic report triggering step; and the forensic report is generated by the electronic contract platform. Moreover, in Embodiment 2, the validity, the legitimacy, and the integrity of the decrypted transaction data are verified by the electronic contract platform; the verification result is transmitted to the blockchain digital deposit platform; and the blockchain digital deposit platform receives the verification result of the decrypted transaction data which is transmitted by the electronic contract platform, to generate the forensic report. Smart contract-based electronic contract forensic may be completed in both embodiments.

For similar parts between the embodiments provided in this application, reference may be made to each other. The specific implementations described above are merely some examples under a general concept of this application, and do not constitute any limitation to the protection scope of this application. For a person skilled in the art, any other implementations derived according to the solutions of this application without creative efforts all fall within the protection scope of this application.

What is claimed is:

1. A smart contract-based electronic contract forensic method, comprising:
initiating a forensic transaction to a blockchain digital deposit platform based on a forensic request for an electronic contract;
verifying the forensic transaction, and executing a smart contract, to generate a forensic token;
generating an execution result based on the forensic token;
obtaining a digest of a deposit transaction based on the execution result;
decrypting the digest, to generate a storage index table;
downloading corresponding pieces of distributed stored data according to the storage index table, and splicing the pieces of data to obtain transaction data;
decrypting the transaction data; and
verifying validity, legitimacy, and integrity of the decrypted transaction data, to generate a forensic report.

2. The smart contract-based electronic contract forensic method according to claim 1, wherein the initiating a forensic transaction to a blockchain digital deposit platform based on a forensic request for an electronic contract is performed according to the following steps:
obtaining the forensic request for the electronic contract;
deciding, based on the forensic request, whether deposit information corresponding to the electronic contract is stored in the blockchain digital deposit platform;
if the deposit information is stored in the blockchain digital deposit platform, deciding whether the deposit transaction exists in the blockchain digital deposit platform; and
if the deposit transaction is stored in the blockchain digital deposit platform, initiating a forensic transaction to the smart contract in the blockchain digital deposit platform.

3. The smart contract-based electronic contract forensic method according to claim 1, before the decrypting the digest, further comprising verifying validity of a private-key signature of the deposit transaction, and if the private-key signature is valid, decrypting the digest, to generate a storage index table.

4. The smart contract-based electronic contract forensic method according to claim 1, further comprising:
if the forensic transaction does not pass the verification, re-initiating the forensic transaction to the smart contract in the blockchain digital deposit platform; and
re-verifying the forensic transaction, until the forensic transaction passes the verification.

5. The smart contract-based electronic contract forensic method according to claim 1, wherein the transaction data comprises several pieces of discretized encrypted sub-deposit data, each piece of the encrypted sub-deposit data contains one indexing code, and the indexing code is unique.

6. The smart contract-based electronic contract forensic method according to claim 5, wherein the downloading corresponding pieces of distributed stored data according to the storage index table, and splicing the pieces of data to obtain transaction data comprises the following steps:
splitting the storage index table into several sub-indexes;
respectively matching the sub-indexes with the plurality of indexing codes, and if a sub-index is successfully matched with the indexing code, downloading the encrypted sub-deposit data corresponding to the indexing code; and
splicing the plurality of pieces of encrypted sub-deposit data to form the transaction data.

7. A smart contract-based electronic contract forensic system, comprising an electronic contract platform configured to initiate a forensic request, and a blockchain digital deposit platform that receives the forensic request, and accesses an electronic contract based on a smart contract, wherein
the electronic contract platform is configured to perform:
a request initiating step: initiating a forensic transaction to a blockchain digital deposit platform based on the forensic request for the electronic contract;
the blockchain digital deposit platform is configured to perform:
a forensic token generating step: verifying the forensic transaction, and executing the smart contract, to generate a forensic token;
an execution result generating step: generating an execution result based on the forensic token;
a digest obtaining step: obtaining a digest of a deposit transaction based on the execution result;
a storage index table generating step: decrypting the digest, to generate a storage index table;
a transaction data generating step: downloading corresponding pieces of distributed stored data according to the storage index table, and splicing the pieces of data to obtain transaction data;
a transaction data decrypting step: decrypting the transaction data; and
a verifying step: verifying validity, legitimacy, and integrity of the decrypted transaction data, and after the verification is completed, sending a verification result to the electronic contract platform; and
the electronic contract platform is further configured to perform:
a forensic report generating step: generating a forensic report after the verification result sent by the blockchain digital deposit platform is received.

8. The smart contract-based electronic contract forensic system according to claim 7, wherein the initiating a forensic transaction to a blockchain digital deposit platform based on the forensic request for the electronic contract is performed according to the following steps:
a forensic request obtaining step: obtaining the forensic request for the electronic contract;
a deposit information deciding step: deciding, based on the forensic request, whether deposit information corresponding to the electronic contract is stored in the blockchain digital deposit platform;
a deposit transaction deciding step: if the deposit information is stored in the blockchain digital deposit platform, deciding whether the deposit transaction exists in the blockchain digital deposit platform; and
a forensic transaction initiating step: if the deposit transaction is stored in the blockchain digital deposit platform, initiating the forensic transaction to the smart contract in the blockchain digital deposit platform.

9. A smart contract-based electronic contract forensic system, comprising an electronic contract platform configured to initiate a forensic request, and a blockchain digital deposit platform that receives the forensic request, and accesses an electronic contract based on a smart contract, wherein
the electronic contract platform is configured to perform:
a request initiating step: initiating a forensic transaction to a blockchain digital deposit platform based on the forensic request for the electronic contract;
the blockchain digital deposit platform is configured to perform:
a forensic token generating step: verifying the forensic transaction, and executing the smart contract, to generate a forensic token;
an execution result generating step: generating an execution result based on the forensic token;
a digest obtaining step: obtaining a digest of a deposit transaction based on the execution result;
a storage index table generating step: decrypting the digest, to generate a storage index table;
a transaction data generating step: downloading corresponding pieces of distributed stored data according to the storage index table, and splicing the pieces of data to obtain transaction data; and
a transaction data decrypting step: decrypting the transaction data; and
the electronic contract platform is further configured to perform:
a verifying step: verifying validity, legitimacy, and integrity of the decrypted transaction data, and transmitting a verification result to the blockchain digital deposit platform; and
the blockchain digital deposit platform is further configured to perform:
a forensic report generating step: generating a forensic report after the verification result of the decrypted transaction data which is transmitted by the electronic contract platform is received.

10. The smart contract-based electronic contract forensic system according to claim 9, wherein the initiating a forensic transaction to a blockchain digital deposit platform based on the forensic request for the electronic contract is performed according to the following steps:
a forensic request obtaining step: obtaining the forensic request for the electronic contract;
a deposit information deciding step: deciding, based on the forensic request, whether deposit information corresponding to the electronic contract is stored in the blockchain digital deposit platform;
a deposit transaction deciding step: if the deposit information is stored in the blockchain digital deposit platform, deciding whether the deposit transaction exists in the blockchain digital deposit platform; and
a forensic transaction initiating step: if the deposit transaction is stored in the blockchain digital deposit platform, initiating the forensic transaction to the smart contract in the blockchain digital deposit platform.
